(19) United States
(12) Patent Application Publication
(10) Pub. No.: US 2009/0002063 A1
(43) Pub. Date: Jan. 1, 2009

(54) Semiconductor Circuit

(75) Inventor: Souji Sunairi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/156,000

(22) Filed: Jun. 12, 2008

(30) Foreign Application Priority Data
Jun. 26, 2007 (JP) 2007-167773

(51) Int. Cl. G05F 3/02

(52) U.S. Cl. 327/540

(57) ABSTRACT

A semiconductor circuit according to an embodiment of the present invention includes a first current mirror operating between a first power supply potential and a second power supply potential, a third power supply potential generated by the first current mirror, a second current mirror operating between the first power supply potential and the second power supply potential, a fourth power supply potential generated by the second current mirror, a circuit operating between the third power supply potential and the fourth power supply potential, and a first conductive type transistor and a second conductive type transistor connected to the circuit in parallel and connected to each other in series.

### BACKGROUND OF THE INVENTION

1. Field of the Invention

The present invention relates to a semiconductor circuit, and more particularly, to a semiconductor circuit suppressing jitter of a clock signal.

2. Description of Related Art

A semiconductor integrated circuit performs high-speed operation based on a clock signal generated by a clock generation macro such as a phase-locked loop (PLL), a delay-locked loop (DLL), or a synchronous-mirror-delay (SMD).

In general, the clock signal is transmitted by a buffer circuit formed by a plurality of inverters. The buffer circuit often operates by an internal power supply voltage generated by an external power supply VDD. When the internal power supply voltage for operating the buffer circuit fluctuates due to a noise, jitter may be caused in the clock signal, which may lead to increase of delay or malfunction of the circuit.

FIG. 3 shows a circuit configuration of FIG. 1 of Japanese Unexamined Patent Application Publication No. 11-186497. As shown in FIG. 3, a resistance element 11 is connected to each of the external power supply VDD and a ground to generate the internal power supply voltage. An inverter circuit element 13 operates by this internal power supply voltage. In a circuit configuration disclosed in Japanese Unexamined Patent Application Publication No. 11-186497, a variation of the internal power supply voltage is suppressed by a capacitance element (capacitor) 12 connected to the inverter circuit element 13 in parallel. Japanese Unexamined Patent Application Publication No. 2006-324485 also discloses a circuit configuration where the capacitor is connected to the inverter in parallel.

While the resistance element 11 is connected to each of the external power supply VDD and the ground to generate the internal power supply voltage in Japanese Unexamined Patent Application Publication No. 11-186497, a circuit configuration where the current mirror is connected to each of the external power supply VDD and the ground is disclosed in Japanese Unexamined Patent Application Publication No. 2002-117671.

In the circuit configuration disclosed in the above-described Japanese Unexamined Patent Application Publication Nos. 11-186497 and 2006-324485, the capacitor is in high impedance state with respect to low-frequency noise, whereby difference between potential variation in the external power supply side and potential variation in the ground side is apparent, and the internal power supply voltage fluctuates. Therefore, it has now been discovered that the jitter of the clock signal output from the buffer circuit increases when the circuit configuration is applied to the buffer circuit transmitting the clock signal.

### SUMMARY

A semiconductor circuit according to one aspect of the present invention includes a first current mirror operating between a first power supply potential and a second power supply potential, a third power supply potential generated by the first current mirror, a second current mirror operating between the first power supply potential and the second power supply potential, a fourth power supply potential generated by the second current mirror, a circuit operating between the third power supply potential and the fourth power supply potential, and a first conductive type transistor and a second conductive type transistor connected to the circuit in parallel and connected to each other in series.

According to the present invention, jitter of a clock signal can be reduced with respect to low-frequency noise.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram of a semiconductor circuit according to an embodiment;

FIG. 2 is a graph showing a voltage change with respect to a noise frequency; and

FIG. 3 is FIG. 1 of Japanese Unexamined Patent Application Publication No. 11-186497.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

The embodiment of the present invention will be described hereinafter in detail. However, the present invention is not limited to the embodiment described below. The description and the drawings are simplified as appropriate for the sake of clarity.

### Embodiment

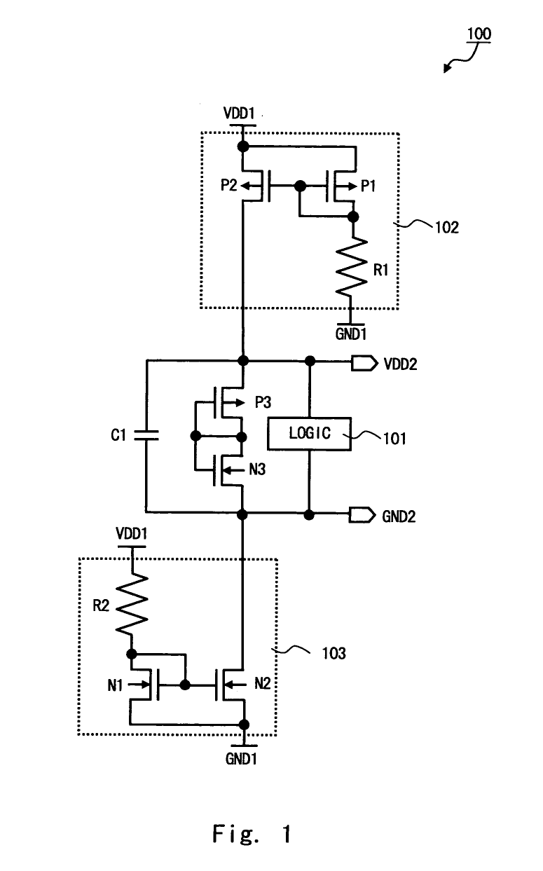

The embodiment of the present invention will be described with reference to the drawings. FIG. 1 is a circuit diagram of a semiconductor circuit according to the embodiment of the present invention. As shown in FIG. 1, a semiconductor circuit 100 according to the present embodiment includes a first power supply VDD1, a second power supply VDD2, a first ground GND1, a second ground GND2, first to third NMOS transistors N1 to N3, first to third PMOS transistors P1 to P3, a capacitor C1, first and second resistors R1 and R2, and a logic circuit 101. A first power supply potential according to the present invention corresponds to the first power supply VDD1, a second power supply potential according to the present invention corresponds to the first ground GND1, a third power supply potential according to the present invention corresponds to the second power supply VDD2, and a fourth power supply potential according to the present invention corresponds to the second ground GND2.

The first PMOS transistor P1 has a source connected to the first power supply VDD1 and a drain connected to one terminal of the first resistor R1. A gate and the drain of the first PMOS transistor P1 are connected to each other. The other end of the first resistor R1 is connected to the first ground GND1.

The second PMOS transistor P2 has a source connected to the first power supply VDD1 and a drain connected to the second power supply VDD2. A gate of the first PMOS transistor P1 and a gate of the second PMOS transistor P2 are connected to each other. In summary, a first current mirror circuit 102 is formed by the first and second PMOS transistors P1 and P2, and the first resistor R1.

To be more specific, if the first PMOS transistor P1 and the second PMOS transistor P2 are the same transistors, current that is equal to the current flowing in the first resistor R1 also flows in the second PMOS transistor P2. Current flowing in the second PMOS transistor P2 can be changed by changing a value of the first resistor R1. Accordingly, potential of the second power supply VDD2 can be set to a desired value.

A source of the first NMOS transistor N1 is connected to the first ground GND1 and a drain thereof is connected to one end of the second resistor R2. The source and the drain of the first NMOS transistor N1 are connected to each other. The other end of the second resistor R2 is connected to the first power supply VDD1.

A source of the second NMOS transistor N2 is connected to the first ground GND1 and a drain thereof is connected to the second ground GND2. A gate of the first NMOS transistor N1 and a gate of the second NMOS transistor N2 are connected to each other. In summary, a second current mirror circuit 103 is formed by the first and second NMOS transistors N1 and N2, and the second resistor R2.

To be more specific, if the first NMOS transistor N1 and the second NMOS transistor N2 are the same transistors, current that is equal to the current flowing in the second resistor R2 also flows in the second NMOS transistor N2. Current flowing in the second NMOS transistor N2 can be changed by changing a value of the second resistor R2. Accordingly, potential of the second ground GND2 can be set to a desired value.

The logic circuit 101 operates between the second ground GND2 and the second power supply VDD2. Although not specifically limited, a buffer circuit transmitting a clock signal is preferably employed as the logic circuit 101, for example. More specifically, the buffer circuit may be formed by a plurality of inverters. The clock signal is generated by a clock generation macro such as a phase-locked loop (PLL), a delay-locked loop (DLL), or a synchronous-mirror-delay (SMD), and is input to the logic circuit 101.

A source of the third PMOS transistor P3 is connected to the second power supply VDD2 and a drain thereof is connected to a drain of the third NMOS transistor N3. A source of the third NMOS transistor N3 is connected to the second ground GND2. In summary, the third PMOS transistor P3 and the third NMOS transistor N3 are connected to each other in series. The third PMOS transistor P3 and the third NMOS transistor N3 that are connected in series are connected to the logic circuit 101 in parallel.

A gate of the third PMOS transistor P3 and a gate of the third NMOS transistor N3 are connected to each other, and this gate and a drain of the third PMOS transistor P3 and the third NMOS transistor N3 are connected to each other. In summary, both of the third PMOS transistor P3 and the third NMOS transistor N3 are diode connected. To be more specific, as will be described later in detail, delay variation of the logic circuit due to process variation can be reduced by such a configuration.

The capacitor C1 is also connected to the logic circuit 101 in parallel. Since there is provided a capacitor C1, variation of potential difference between the second ground GND2 and the second power supply VDD2 due to the noise in the first power supply VDD1 or the first ground GND1 can be reduced.

As described above, in the present invention, the current mirror is connected to the external power supply (the first power supply VDD1 and the first ground GND1) instead of using the resistor, so as to generate the internal power supply voltage (the second power supply VDD2 and the second ground GND2). Accordingly, potential difference between the second power supply VDD2 and the second ground GND2 can be held constant, whereby jitter in the clock signal can be suppressed. The mechanism thereof will be described in detail with some numerical expressions.

When a voltage change amount ΔV_{VDD1} is generated in the first power supply VDD1 due to the noise, a current change amount ΔI_{P1}, flowing in the first PMOS transistor P1 and the first resistor R1, and a gate voltage change amount ΔV_{PG} of the first PMOS transistor P1 and the second PMOS transistor P2 can be expressed by the following expressions (1) and (2) using a resistance value R₁ of the first resistor R₁ and a transconductance g_{m(P1)} of the first PMOS transistor P1.

ΔI_{P1}=g_{m(P1)}·(ΔV_{VDD1}−ΔV_{PG}) (1)

ΔV_{PG}=R₁·ΔI_{P1} (2)

From the expressions (1) and (2), the following expression (3) can be obtained.

ΔV_{PG}/ΔV_{VDD1}=g_{m(P1)}·R₁/(g_{m(P1)}·R₁+1) (3)

A voltage change amount ΔV_{GS(P1)} in the gate and source of the first PMOS transistor P1 can be expressed by the following expression (4).

ΔV_{GS(P1)}=ΔV_{PG}−ΔV_{VDD1}=−ΔV_{VDD1}/(g_{m(P1)}·R₁+1) (4)

Further, a current change amount ΔI_{P2} flowing in the second PMOS transistor P2 can be expressed by the following expression (6) from the expression (5) using a transconductance g_{m(P2)} of the second PMOS transistor P2.

ΔI_{P2}/ΔV_{GS(P2)}=g_{m(P2)}=K·g_{m(P1)} (K is an integer) (5)

ΔI_{P2}=K·g_{m(P1)}·ΔV_{GS(P2)}=K·g_{m(P1)}·ΔV_{GS(P1)} (6)

A voltage change amount ΔV_{VDD2} of the second power supply VDD2 that is to be obtained can be expressed by the following expression:

ΔV_{VDD2}=Rₓ·ΔI_{P2} (7)

wherein Rₓ is a combined resistance of a resistor of the logic circuit R_{LOGIC} and resistance components of the third NMOS transistor N3 and the third PMOS transistor P3. By using a transconductance g_{m(N3)} of the third NMOS transistor N3 and a transconductance g_{m(P3)} of the third PMOS transistor P3, 1/Rₓ=1/(1/g_{m(P3)}+1/g_{m(N3)})+1/R_{LOGIC} can be satisfied. If the expressions (4) and (6) are assigned to the expression (7), the following expression can be obtained.

ΔV_{VDD2}=−{Rₓ·K·g_{m(P1)}/(g_{m(P1)}·R₁+1)}·ΔV_{VDD1} (8)

In the same way, when the voltage change amount ΔV_{VDD1} is generated in the first power supply VDD1 due to the noise, a current change amount ΔI_{N1} flowing in the first NMOS transistor N1 and the second resistor R2, and a gate voltage change amount ΔV_{NG} of the first NMOS transistor N1 and the second NMOS transistor N2 can be expressed by the following expressions (9) and (10) using a resistance value R₂ of the second resistor R2 and a transconductance g_{m(N1)} of the first NMOS transistor N1.

ΔI_{N1}=g_{m(N1)}·ΔV_{NG} (9)

ΔV_{VDD1}−ΔV_{NG}=R₂·ΔI_{N1} (10)

From the above expressions (9) and (10), the following expression (11) can be introduced.

ΔV_{NG}=ΔV_{GS(N1)}=ΔV_{VDD1}/(g_{m(N1)}·R₂+1) (11)

Further, a current change amount ΔI_{N2} flowing in the second NMOS transistor N2 can be expressed by the following expression (13) from the expression (12) using a transconductance g_{m(N2)} of the second NMOS transistor N2.

ΔI_{N2}/ΔV_{GS(N2)}=ΔI_{N2}/ΔV_{NG}=g_{m(N2)}

=N·g_{m(N1)} (N is an integer) (12)

ΔI_{N2}=N·g_{m(N1)}·ΔV_{GS(N2)}=N·g_{m(N1)}·ΔV_{GS(N1)} (13)

A Voltage change amount ΔV_{GND2} of the second ground GND2 that is to be obtained can be expressed by the following expression:

ΔV_{GND2}=Rₓ·ΔI_{N2} (14)

wherein Rₓ is the same as in the expression (7). If the expressions (11) and (13) are assigned to the expression (14), the following expression (15) can be obtained.

ΔV_{GND2}={Rₓ·N·g_{m(N1)}/(g_{m(N1)}·R₂+1)}·ΔV_{VDD1} (15)

If the parameter value where the values of the expressions (8) and (15) are made equal is set, the voltage change amount ΔV_{VDD1} generated at the first power supply VDD1 can be decreased to the same degree as the second power supply VDD2 and the second ground GND2 and can be transmitted in synchronization therewith. Accordingly, the potential difference between the second power supply VDD2 and the second ground GND2 can be held constant, whereby the jitter in the clock signal can be suppressed. The same description can be applied to a case where the noise is generated in the first ground GND1.

As stated above, according to the present invention, delay variation of the logic circuit due to the process variation can be reduced. The mechanism thereof will be described hereinafter in detail.

Each of the threshold value voltages of the third PMOS transistor P3 and the third NMOS transistor N3 is expressed by Vₜₚ, Vₜₙ, respectively. In the semiconductor circuit 100 according to the present embodiment, since both of the third PMOS transistor P3 and the third NMOS transistor N3 are diode connected, voltage decrease in the third PMOS transistor P3 and voltage decrease in the third NMOS transistor N3 are expressed by Vₜₚ, Vₜₙ, respectively. Accordingly, potential difference between the second power supply VDD2 and the second ground GND2 can be expressed by V_{VDD2}−V_{GND2}≈Vₜₚ+Vₜₙ.

When the threshold value voltage of the transistor forming the logic circuit increases due to the process variation, delay of the logic circuit also increases. In this case, if the driving voltage of the logic circuit can be made larger, the delay can be prevented. In the semiconductor circuit 100 according to the present embodiment, when the threshold value voltages Vₜₚ, Vₜₙ of the PMOS transistor and the NMOS transistor forming the logic circuit increase, the driving voltage of the logic circuit also increases, whereby the delay can be reduced. In the present invention, the diode connected PMOS transistor and the diode connected NMOS transistor are connected in series, which makes it possible to respond to the process variation of both of the PMOS transistor and the NMOS transistor.

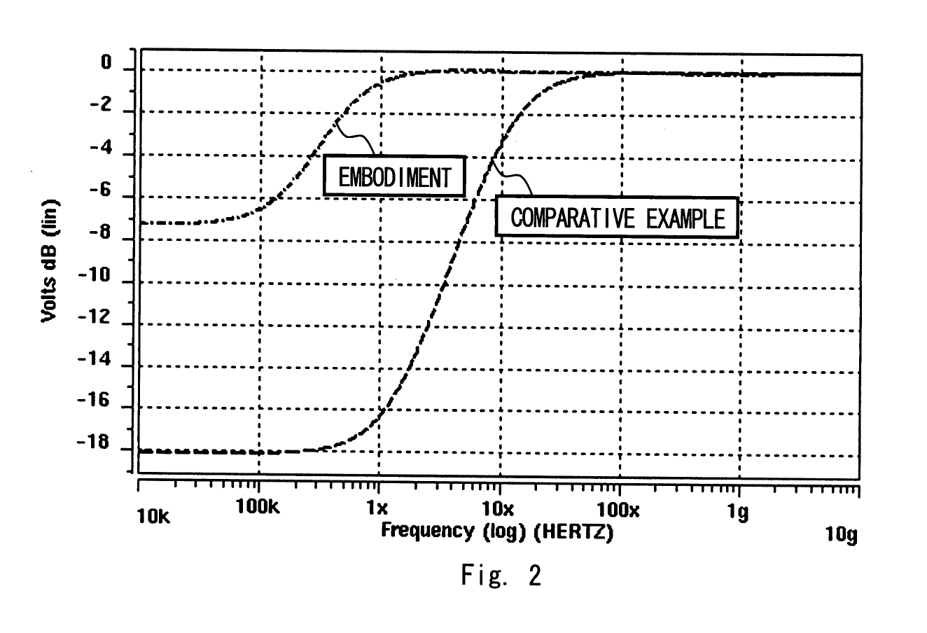

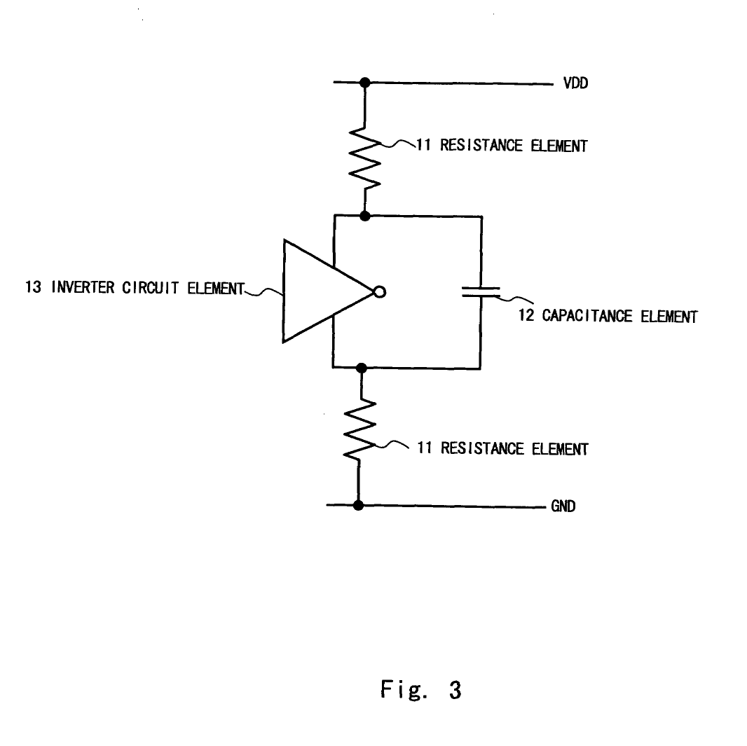

FIG. 2 shows a simulation result when the noise of AC1V is added to the first power supply VDD1 in the circuit configurations of the embodiment and a comparative example of the present invention to change the noise frequency. A circuit where the logic circuit 101 shown in FIG. 1 is formed by one inverter is employed as the embodiment. The circuit shown in FIG. 3 is employed as the comparative example.

A horizontal axis of FIG. 2 shows the noise frequency in a log scale. A vertical axis shows a ratio ΔV_{GND2}/ΔV_{VDD2} between the voltage change amount ΔV_{GND2} of the second ground GND2 and the voltage change amount ΔV_{VDD2} of the second power supply VDD2 in decibel or 20·log₁₀(ΔV_{GND2}/ΔV_{VDD2}).

As shown in FIG. 2, in the noise frequency of 100 MHz or more, both of the voltage change amount ΔV_{GND2} of the second ground GND2 and the voltage change amount ΔV_{VDD2} of the second power supply VDD2 are 0 dB in both of the comparative example and the embodiment. This is mainly due to the capacitor C1 in FIG. 1 and the capacitance element (capacitor) 12 in FIG. 3. More specifically, it is because the impedance of the capacitor decreases and voltage change in the power supply side is easily transmitted to the ground side as the frequency becomes higher.

In the related example, when the noise frequency is equal to or less than 100 MHz, the difference between the voltage change amount ΔV_{GND2} of the second ground GND2 and the voltage change amount ΔV_{VDD2} of the second power supply VDD2 increases and the difference is decreased to −18 dB, and this value is kept constant.

On the other hand, in the embodiment, the difference between the voltage change amount ΔV_{GND2} of the second ground GND2 and the voltage change amount ΔV_{VDD2} of the second power supply VDD2 is equal until the noise frequency of 1 MHz. In other words, according to the present embodiment, it is possible to completely suppress the variation of the potential difference between the second power supply VDD2 and the second ground GND2 until the noise frequency two orders of magnitude lower than that of the related example. In the noise having frequency of equal to or lower than 100 MHz, although the difference between the voltage change amount ΔV_{GND2} of the second ground GND2 and the voltage change amount ΔV_{VDD2} of the second power supply VDD2 increases, the difference is only decreased to −7 dB, and this value is kept constant. In summary, the change amount of the potential difference between the second power supply VDD2 and the second ground GND2 is smaller than that of the comparative example. The change amount can be made smaller because both of the third PMOS transistor P3 and the third NMOS transistor N3 that are mainly connected in series are diode connected. More specifically, it is because a synthetic impedance between the second power supply VDD2 and the second ground GND2 decreases due to the third PMOS transistor P3 and the third NMOS transistor N3.

It is apparent that the present invention is not limited to the above embodiments, but may be modified and changed without departing from the scope and spirit of the invention.

What is claimed is:

1. A semiconductor circuit comprising:
a first current mirror operating between a first power supply potential and a second power supply potential;
a third power supply potential generated by the first current mirror;
a second current mirror operating between the first power supply potential and the second power supply potential;
a fourth power supply potential generated by the second current mirror;
a circuit operating between the third power supply potential and the fourth power supply potential; and
a first conductive type transistor and a second conductive type transistor connected to the circuit in parallel and connected to each other in series.

2. The semiconductor circuit according to claim 1, wherein both of the first conductive type transistor and the second conductive type transistor are diode connected.

3. The semiconductor circuit according to claim 1, further comprising a capacitor connected in parallel to the circuit operating between the third power supply potential and the fourth power supply potential and to the first and second conductive type transistors connected to each other in series.

4. The semiconductor circuit according to claim 1, wherein the circuit operating between the third power supply potential and the fourth power supply potential is the circuit transmitting a clock signal.

5. The semiconductor circuit according to claim 4, wherein the circuit transmitting the clock signal includes a plurality of inverters.

6. The semiconductor circuit according to claim 4, wherein the clock signal is generated by a phase-locked loop.
